(19) United States
(12) Patent Application Publication
(10) Pub. No.: US 2015/0078736 A1
(43) Pub. Date: Mar. 19, 2015

(54) UNDERWATER IMAGING SYSTEM

(71) Applicant: John S. Berg, Franklin, MA (US)

(72) Inventor: John S. Berg, Franklin, MA (US)

(21) Appl. No.: 14/491,394

(22) Filed: Sep. 19, 2014

Related U.S. Application Data
(60) Provisional application No. 61/879,696, filed on Sep. 19, 2013.

(51) Int. Cl. G03B 17/08

(52) U.S. Cl. CPC G03B 17/08
USPC 396/28

(57) ABSTRACT

An imaging system designed for use in a low visibility, underwater environment includes a short wavelength light source, such as an ultraviolet LED, for illuminating an object and a camera for capturing images of the object. The exterior of the object is applied with a light absorptive coating, such as a phosphorescent coating. In use, some the light emitted by the light source is reflected by particles suspended in the water, such as silt or algae, at the same relatively short wavelength as initially emitted. However, some of the light emitted by the light source is absorbed by the coated object and re-emitted at a relatively long wavelength based on a principle of fluorescence known as Stokes shift. Accordingly, a cutoff filter disposed in front of the camera enhances visibility of the object by filtering out the short wavelength light reflected by particles suspended in the immediate environment.

### FIELD OF THE INVENTION

The present invention relates generally to imaging systems and more particularly to imaging systems designed principally for use in underwater applications.

### BACKGROUND OF THE INVENTION

Underwater imaging systems are often utilized in a variety of different applications. For instance, underwater imaging systems are often used to assist in the installation, repair and/or maintenance of underwater conduits (e.g., pipelines), oil wells, or other structures disposed in limited visibility environments (e.g., on the ocean floor).

Underwater imaging systems typically include a light source for generating high power light and a camera to provide still and/or video images of any objects present within the camera range (e.g., for viewing at a remote location). In use, the high power light produced by the light source travels through the water and ultimately illuminates any objects within the camera range to the extent necessary that images of the objects can be captured by the camera.

For example, FIG. 1 is a simplified schematic representation of an underwater imaging system 11 of the type as described above. As can be seen, system 11 comprises a light source, or light, 13 for producing high power light and a camera 15 for capturing objects illuminated by light source 13.

Although useful and well known in the art, underwater imaging systems of the type as described above have been found to suffer from a notable shortcoming. Specifically, as shown in FIG. 1, a relatively high concentration of suspended particles, such as silt or algae, is often present in water between light source 13 and a desired object 17, the region with a high concentration of suspended particles being identified generally by reference numeral 19. In use, the majority of the light emitted from light source 13, the emitted light being represented collectively as light rays 21, reflects off the suspended particles present within region 19 instead of object 17, the reflected light being identified collectively as light rays 23. At least a portion of light 23 is reflected off the suspended particles back into camera 15, thereby resulting in an overly-reflected, blinded image that obscures viewing of desired object 17.

### SUMMARY OF THE INVENTION

It is an object of the present invention to provide a new and improved underwater imaging system.

It is another object of the present invention to provide a new and improved underwater imaging system that enhances the visibility a desired object.

It is yet another object of the present invention to provide a new and improved underwater imaging system of the type as described above that is particularly well suited for use in underwater environments with a relatively high concentration of suspended particles, such as silt or algae.

It is still another object of the present invention to provide an underwater imaging system of the type as described above that allows for the capture of an image of the desired object without any obscuring from light illuminated off suspended particles.

It is yet still another object of the present invention to provide an underwater imaging system of the type as described above that has a limited number of parts, is inexpensive to manufacture and is simple to use.

Accordingly, as one feature of the present invention, there is provided an imaging system for use in a low visibility environment, the imaging system comprising (a) an object disposed in the low visibility environment, at least a portion of the object having an exterior coating that is adapted to absorb light, (b) a light source for illuminating the object, the light source being adapted to produce light with a wavelength of no greater than 750 nm, and (c) a camera for capturing at least one image of the object illuminated by the light source.

As another feature of the present invention, there is provided a method for capturing an image of an object in a low visibility environment using a camera, the object having an exterior, the method comprising the steps of (a) coating at least a portion of the exterior of the object with a light absorptive coating, (b) illuminating the object with a light source adapted to produce light with a wavelength of no greater than 750 nm, and (c) capturing the image of the object illuminated by the light source using the camera.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 a simplified schematic representation of an underwater imaging system that is well known in the art;

FIG. 2 is a simplified schematic representation of an underwater imaging system constructed according to the teachings of the present invention;

FIG. 3 is a graph that represents the intensity of light in relation to wavelength, the graph depicting a shift in wavelength that occurs between light absorbed by an object with a light absorptive coating and the light subsequently emitted by the coated object;

FIGS. 4(a), 4(b) and 4(c) are Jablonski energy diagrams depicting photon absorption through fluorescence, phosphorescence, and delayed fluorescence, respectively; and

FIGS. 5(a)-(c) are a series of photographs that illustrate results obtained through implementation of the underwater imaging system shown in FIG. 2.

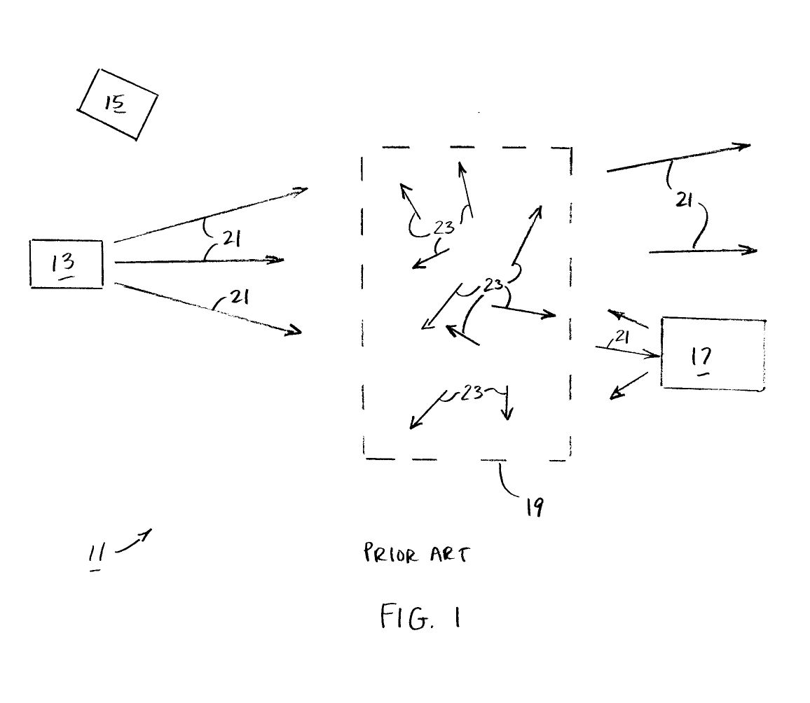

### DETAILED DESCRIPTION OF THE INVENTION

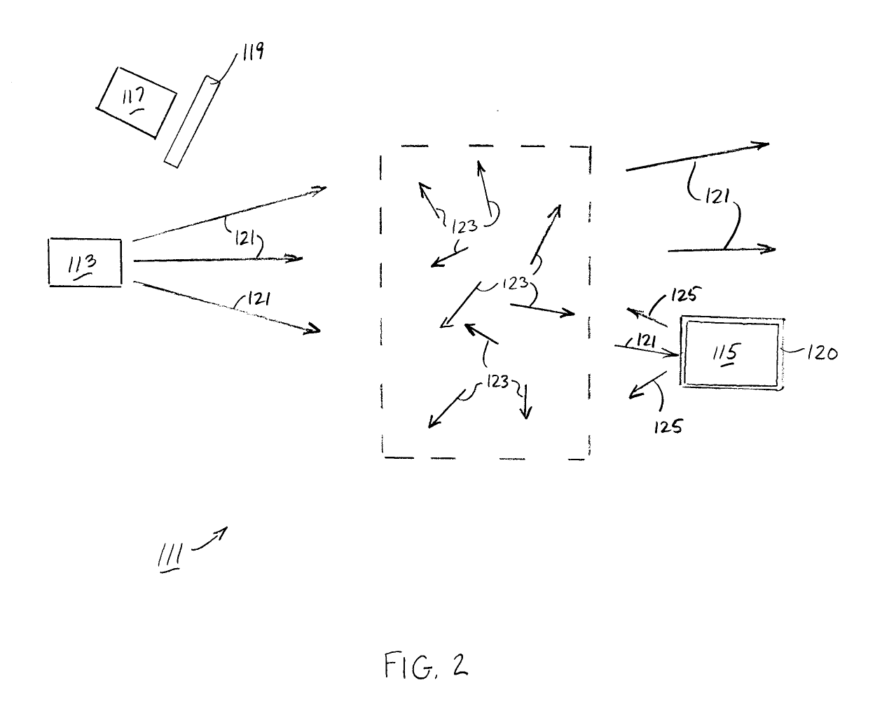

Referring now to FIG. 2, there is shown a simplified schematic representation of an underwater imaging system constructed according to the teachings of the present invention, the underwater imaging system being identified generally by reference numeral 111. As will be described in detail below, system 111 is designed to enhance the visibility of a desired object in an underwater environment by filtering light reflected by particles, such as silt or algae, which are suspended in the water.

It should be noted that system 111 is particularly well suited for use in underwater environments with relatively low visibility and relatively high concentrations of suspended particles. However, it is to be understood that system 111 is not limited to underwater environments. Rather, it is envisioned that system 111 could be similarly implemented in other types of environments with relatively low visibility and relatively high concentration of suspended particles, such as in a cavern, without departing from the spirit of the present invention.

As can be seen, imaging system 111 is similar to prior art imaging system 11 in that imaging system 111 comprises a light source 113 for illuminating a target object 115 (e.g., an underwater cable) within the underwater environment and a camera 117 for capturing images of the underwater environment, including object 115. As will be explained in detail below, imaging system 111 is specifically designed to enhance the visibility of target object 115 by filtering light reflected by particles suspended in the immediate environment.

Underwater imaging system 111 differs from underwater imaging system 11 in the following three ways in order to enhance visibility of target object 115.

As a first distinction, light source 113 differs from a conventional, high power, white light source, such as light source 13, in that light source 113 is adapted to produce light of a relatively short wavelength. Specifically, as defined herein, light source 113 represents any illumination device that is adapted to produce light of a relatively short wavelength, either directly or through subsequent modulation/filtering. For example, light source 113 may be in the form of an ultraviolet (UV) light emitting diode (LED) of the type sold by Luminus Devices, Inc., of Billerica, Mass. under its CBT-120 line of LEDs. Because it has been found that underwater environments are capable of transmitting light well in the 300-750 nm range (often at underwater depths approaching 100 meters), it is preferred that source 113 emit light in the aforementioned range.

As a second distinction, underwater imaging system 111 includes a long wavelength pass cutoff filter 119 that is disposed directly in front of the imaging lens for camera 117. For example, cutoff filter 119 may be in the form of a 425 nm cutoff filter of the type manufactured and sold by Thorlabs, Inc., of Newton, N.J. It is to be understood that cutoff filter 119 is an optional component that, when incorporated into imaging system 111, filters short wavelength light generated in the immediate underwater environment. Accordingly, through filtering of reflected light using long wavelength pass cutoff filter 119 and increasing the gain of the captured image, an enhanced outline of target object 115 can be achieved, as will be explained further below.

As a third distinction, at least a portion of the exterior of target object 115 is preferably applied with a fluorescent, phosphorescent, or stokes-shift coating 120 (i.e., a coating adapted to absorb light).

For example, object 115 may be coated with fluorescent nanocrystals of the type manufactured and sold under the Trilite™ line of fluorescent nanocrystals by Cytodiagnostics Inc., of Burlington, Ontario. As can be appreciated, flourescent nanocrystals of the type referenced above, which are commonly available in both organic and aqueous formulations, are designed with a maximum emission wavelength in the range between 415-725 nm.

As another example, object 115 may be coated with fluorescent dyes of the type manufactured and sold under the Cyto™ line of fluorescent dyes by Cytodiagnostics, Inc., of Burlington, Ontario. As can be appreciated, fluorescent dyes of the type referenced above are available with maximum excitation and emission wavelengths that span the visible and infrared spectrum (e.g., with a maximum excitation wavelength in the range of 418-704 nm and a maximum emission wavelength in the range of 467-723 nm).

In use, light produced by short wavelength light source 113 (represented herein as light rays 121) is reflected by particles suspended in the water (e.g., sand, rock, dust-like sediment, etc.) at the same shortened wavelength as initially emitted (the reflected light being represented as light rays 123). By contrast, light 121 produced by short wavelength light source 113 that is absorbed by coated object 115 is re-emitted at a relatively long wavelength (the re-emitted light being represented as light rays 125). In this manner, by filtering the shorter wavelength light (i.e., light 121 and 123), camera 117 can effectively enhance the image produced from the longer wavelength light emitted from target object 115 (i.e., light 125) without interference from the intermediate light reflected from the suspended particles (i.e., light 123).

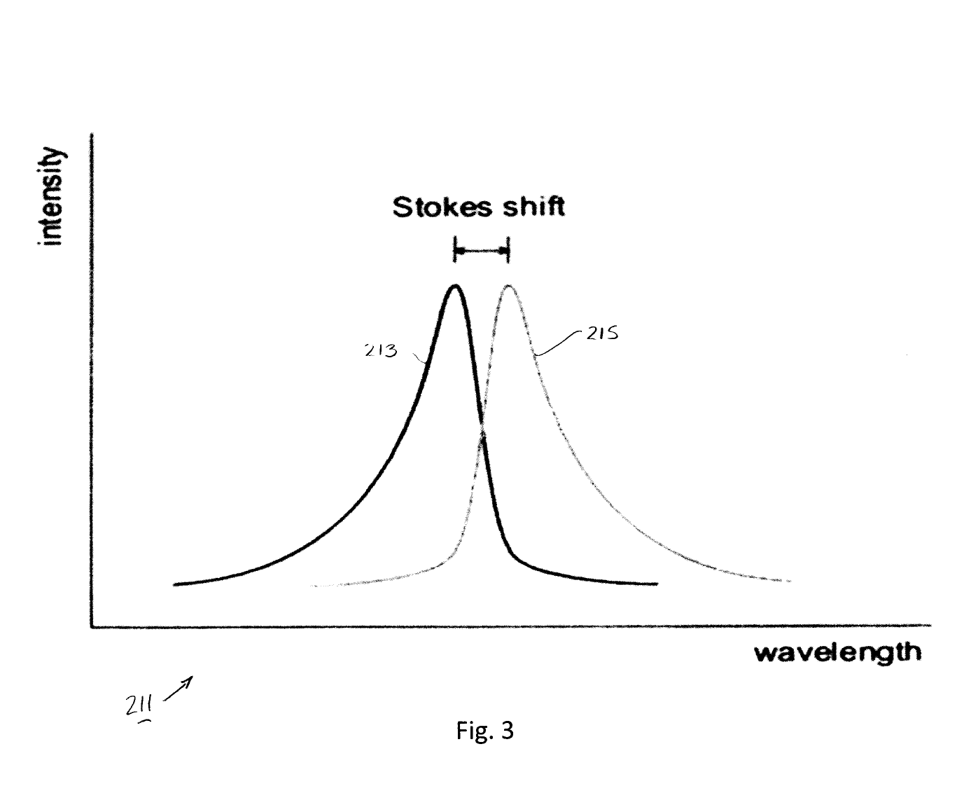

It is to be understood that light absorbed by coated object 115 is re-emitted at a longer wavelength (lower energy level) as a result of a principle of fluorescence known as Stokes shift. Referring now to FIG. 3, there is shown a graph that depicts the intensity of light in relation to wavelength, the graph being identified generally by reference numeral 211. As can be seen, a shift in wavelength occurs between the light absorbed by coated object 115 (the absorbed light being identified generally by reference numeral 213) and the light subsequently emitted by coated object 115 (the emitted light being identified generally by reference numeral 215).

As can be appreciated, the fluorescence of light by an object (e.g., coated object 115) results in re-emission of longer wavelength photons (i.e., photons with lower energy) because the object has absorbed some of the photon energy. This shift in energy (and corresponding increase in wavelength) between the absorbed light (e.g., light 213) and the re-emitted light (e.g., light 215) is commonly referred to in the art as Stokes shift.

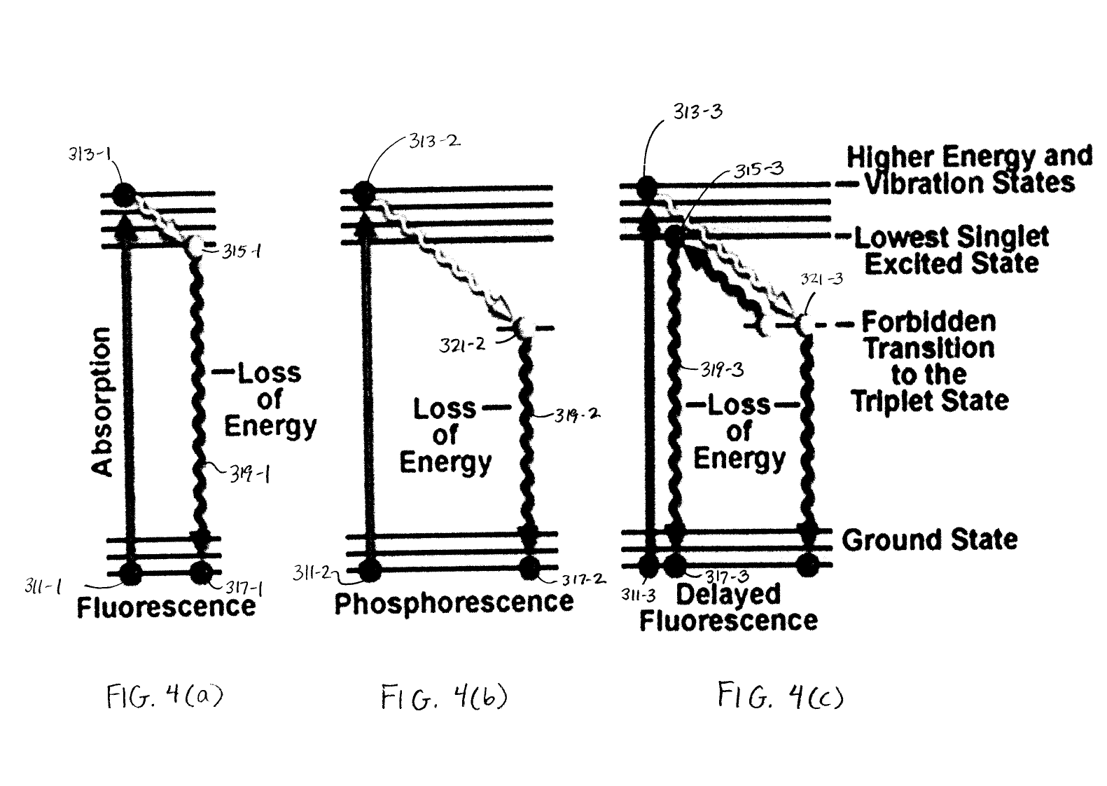

Photon absorption is sometimes depicted diagrammatically using Joblonski energy diagrams. Referring now to FIGS. 4(a), 4(b) and 4(c), there are shown Jablonski energy diagrams depicting photon absorption through fluorescence, phosphorescence, and delayed fluorescence, respectively. As can be seen in each of FIGS. 4(a), 4(b) and 4(c), prior to excitation, the electronic configuration of the molecule is described as being in the ground state, as represented by reference numerals 311-1, 311-2 and 311-3, respectively. Upon absorbing a photon of excitation light, usually of short wavelengths, electrons 311-1, 311-2 and 311-3 may be raised to a higher energy and vibrational excited state, as represented by reference numerals 313-1, 313-2 and 313-3, respectively, the aforementioned process often taking as little as a quadrillionth of a second (a time period commonly referred to as a femtosecond, 10E-15 seconds).

In fluorescence, as shown in FIG. 4(a), during an interval of approximately a trillionth of a second (a picosecond or 10E-12 seconds), the excited electron 313-1 may lose some vibrational energy to the surrounding environment and return to what is called the lowest excited singlet state, as represented by reference numeral 315-1. From the lowest excited singlet state 315-1, the electrons are then able to “relax” back to ground state, as represented by reference numeral 317-1, through the simultaneous emission of fluorescent light, as represented by reference numeral 319-1. The emitted fluorescent light always has a longer wavelength than the excitation light by virtue of Stokes Law, the fluorescent light emitting for as long as the excitation illumination bathes the fluorescent specimen. Once the exciting radiation is halted, the fluorescence ceases.

As noted above and as shown in FIG. 4(a), once an electron is in the excited state, excited electron 313-1 slowly relaxes through vibrational effects to lowest excited singlet state 315-1. Thereafter, the electron can then drop back to ground state 317-1 by emitting a photon (e.g., through fluorescence). However, as shown in FIG. 4(b), occasionally an excited electron 313-2, instead of relaxing to the lowest singlet state through vibrational interactions, makes a forbidden transition to the exited triplet state, as represented by reference numeral 321-2. From excited triplet state 321-2, the electron returns to the ground state, as represented by reference numeral 317-2, through a process where the emission of radiation 319-2 is delayed for up to several seconds or more. This phenomenon is characteristic of phosphorescence.

As seen most clearly in FIG. 4(c), in some instances, an excited electron 313-3 may make a forbidden transition to the excited triplet state, as represented by reference numeral 321-3, and then subsequently return back to the lowest excited singlet state 315-3. Thereafter, the returned electron relaxes back to ground state 317-3 through the emission of fluorescent light, as represented by reference numeral 319-3. Because the aforementioned sequence takes a little longer than usual fluorescence (by approximately a microsecond or two), this action is commonly referred to as delayed fluorescence in the art.

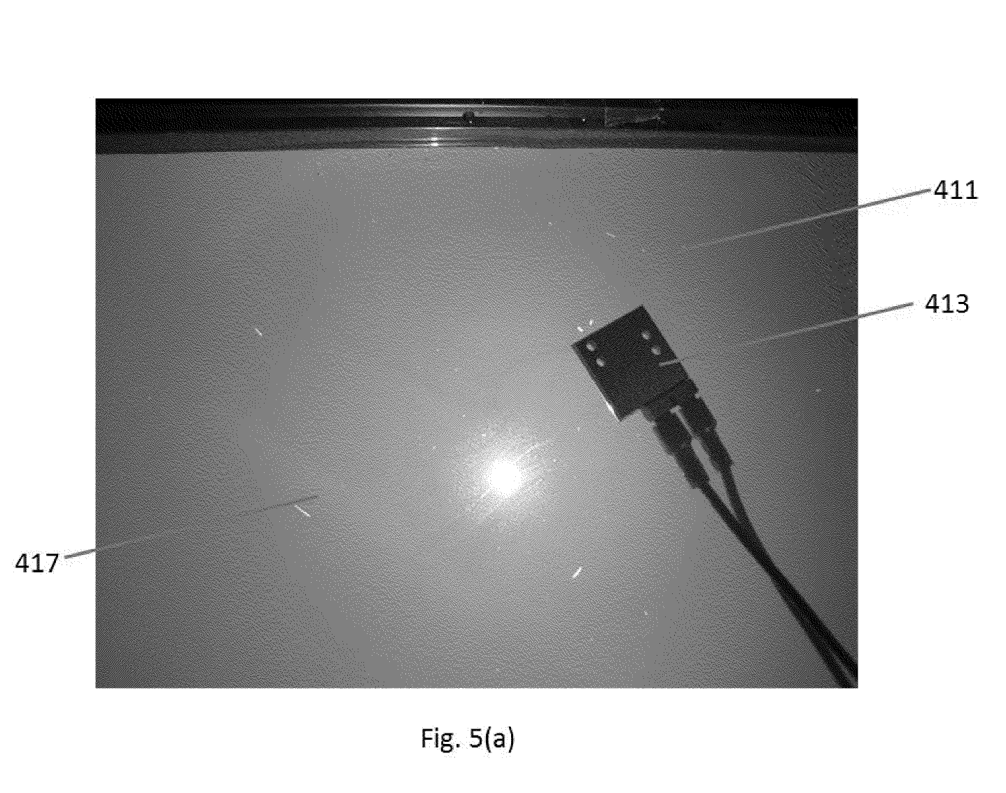

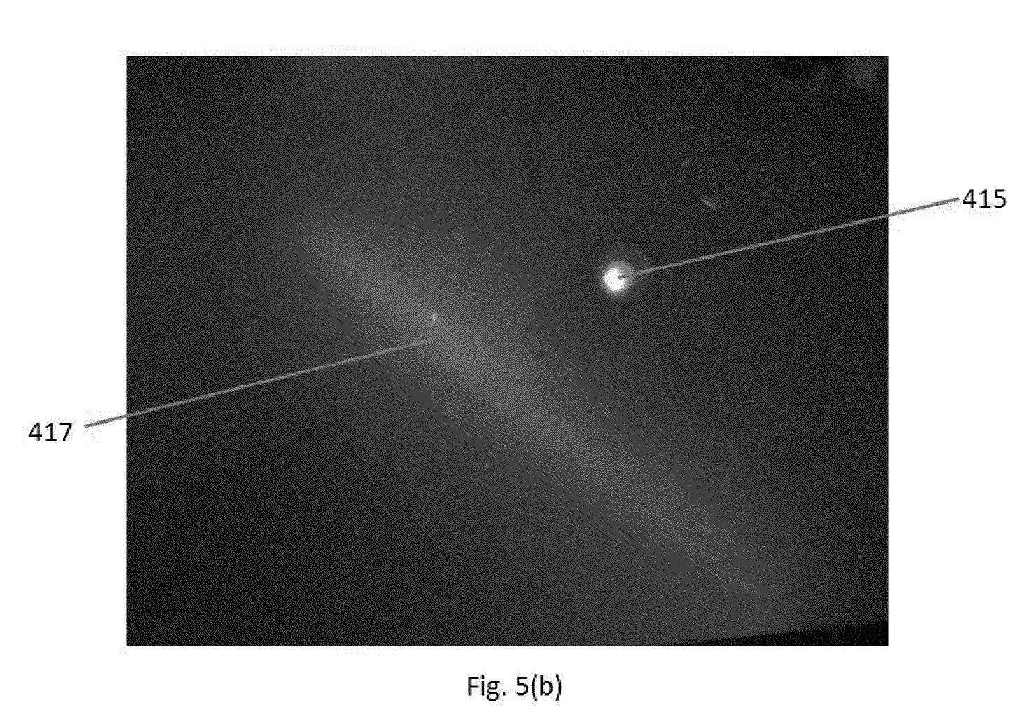

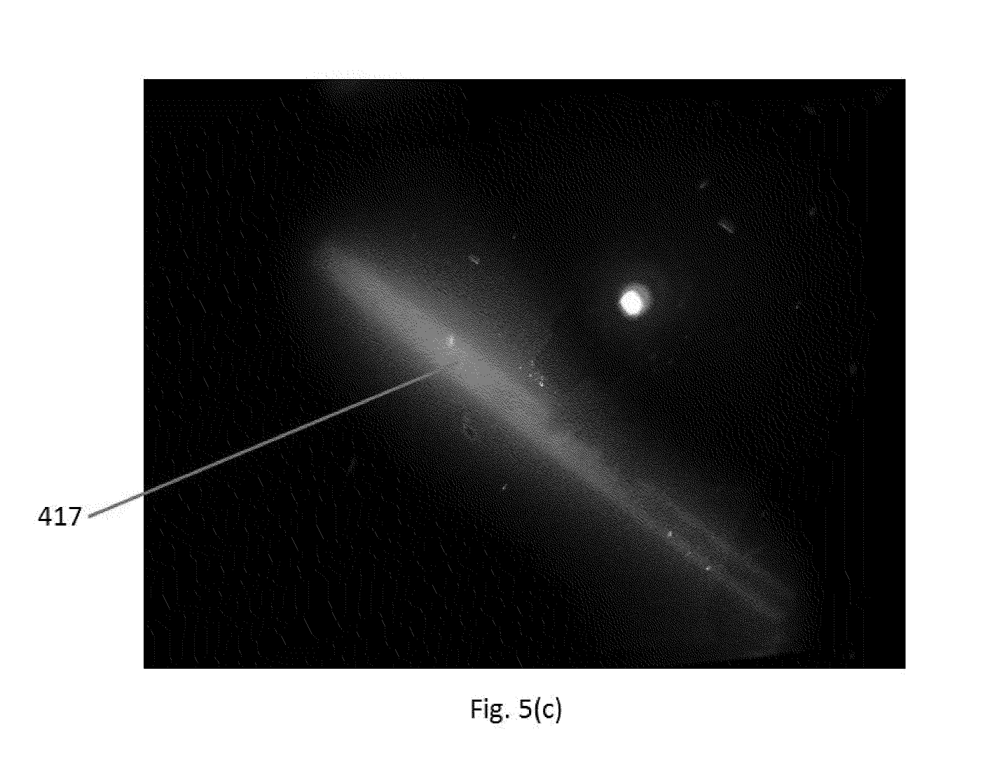

Referring now to FIGS. 5(a)-(c), there are shown a series of photographs that illustrate a demonstration of the improved functionality of underwater imaging system 111. In FIG. 5(a), an aquarium 411 (representing the underwater environment) is shown filled with silt (i.e., granular material, such as sand or rock) suspended in water. As can be seen, the application of short wavelength light from a traditional, high brightness, white light source 413 is reflected off the silt and is scatted back to the camera, thereby obscuring view of a target object 417 located within aquarium 411.

In FIG. 5(b), by utilizing a short wavelength light source 415 (in place of a traditional white light source 413) and applying a stoke-shift (light absorptive) coating to target object 417, which is represented herein as an elongated, cylindrical pipe, the camera is better able to view target object 417. In FIG. 5(c), an even clearer outline of target object 417 is achieved through (i) filtering of the reflected light using a long wavelength pass cutoff filter and (ii) enhancing the gain of the captured image.

It is to be understood that the embodiment shown in the present invention is intended to be merely exemplary and those skilled in the art shall be able to make numerous variations and modifications without departing from the spirit of the present invention. All such variations and modifications are intended to be within the scope of the present invention as defined in the appended claims.

As an example, it should be noted that elements of imaging system 111 could be modified to adapt to the known variances in the light absorption characteristics of different underwater environments. In particular, it is to be understood that the coefficient of light absorption varies between different ocean locations around the world. In view thereof, optimization of system 111 could be obtained for a particular environment by either (i) modifying the illumination wavelength generated by light source 113, (ii) utilizing particular filters 119, and/or (iii) selecting a specific type of coating to be applied to object 115.

As a second example, it is envisioned that, instead of using filter 119, light produced from light source 113 could be strobed (i.e., briefly turned off) between image capture frames. Specifically, as referenced above, since stokes shift may be delayed from picoseconds to microseconds between absorption and re-emission, it is envisioned that image capture be taken when no directly illuminated light is present, thereby increasing contrast and eliminating reflection from suspended sediment.

To optimize the advantages associated with strobing light source 113, it is preferred that camera 117 be synchronized with light source 113 so as to either mechanically or electrically shutter, or block, light from its internal light detection sensor during the exact period of time when light source 113 is not producing direct light (i.e., light 121). In this capacity, the light detection sensor in camera 117 would only be capable of integrating photons from light produced by fluorescing objects (i.e., light 125). To further ensure that the light detected by camera 117 is limited to the re-emitted light (i.e., light 125), the aforementioned shutter mechanism is preferably designed to open only during the estimated period of fluorescence (i.e., to directly correlate with estimated delay of light re-emission from light-absorptive coating 120).

As a third example, it is envisioned that multiple coatings could be applied to target object 115 to enhance image capture. Specifically, light of multiple wavelengths (e.g., light selected from the group consisting 450 nm, 490 nm, 525 nm, 540 nm, 575 nm, 630 nm, and 665 nm wavelength light) may be absorbed and re-emitted from a target object by using a plurality of different fluorescent coatings. The multiple colors of re-emitted wavelengths are then passed through notch filters of selective wavelengths.

In addition, it is to be understood that multiple colors (i.e., varying wavelength light) may be generated by light source 113, each color generated preferably falling outside of the target, or filtered, wavelength of re-emitted light. Accordingly, multiple images can be independently captured (each using a light of a different wavelength) and subsequently combined to provide a high contrast, enhanced image that is not polluted by the light from competing, or interfering, emissions.

As a fourth example, it is envisioned that light-absorptive coating 120 could be provided with an attractive property relative to target object 115. In this manner, coating 120 could be subsequently applied to an object already deployed in a particular environment that would otherwise render treatment with a light-absorptive material difficult.

For instance, with respect to a target object 115 that is both metallic and already located in an underwater environment (e.g., an underwater pipeline), coating 120 may be in the form of a plurality of individual magnetic particles coated with a light-absorptive material (e.g., with a dust-like consistency). As such, the coated magnetic particles could be readily applied to the exterior of the underwater object and retained to its exterior surface through the principle of magnetic attraction.

Similarly, if target object 115 is a supply of oil present in a body of water (e.g., as the result of an oil spill), coating 120 may be in the form of an oleophylic article applied with a light-absorptive material. Accordingly, due to the attraction between the coated oleophylic article and the oil, system 111 could be used to tag and track oil flows.

What is claimed is:

1. An imaging system for use in a low visibility environment, the imaging system comprising:
(a) an object disposed in the low visibility environment, at least a portion of the object having an exterior coating that is adapted to absorb light;
(b) a light source for illuminating the object, the light source being adapted to produce light with a wavelength of no greater than 750 nm; and
(c) a camera for capturing at least one image of the object illuminated by the light source.

2. The imaging system as claimed in claim 1 wherein the exterior coating on the object is a fluorescent coating.

3. The imaging system as claimed in claim 1 wherein the exterior coating on the object is a phosphorescent coating.

4. The imaging system as claimed in claim 1 wherein the exterior coating on the object is a stokes-shift coating.

5. The imaging system as claimed in claim 2 wherein the exterior coating on the object is a fluorescent coating with a maximum emission wavelength in the range between 415 nm and 725 nm.

6. The imaging system as claimed in claim 1 wherein the exterior coating on the object includes at least two coatings with different maximum emission wavelengths.

7. The imaging system as claimed in claim 1 wherein the exterior coating is provided with an attractive property relative to the object.

8. The imaging system as claimed in claim 1 wherein the light source is adapted to produce light with a wavelength in the range of 300-750 nm.

9. The imaging system as claimed in claim 1 wherein the light source is in the form of a light emitting diode adapted to produce ultraviolet light.

10. The imaging system as claimed in claim 1 wherein the light source is adapted to produce strobed light.

11. The imaging system as claimed in claim 10 wherein the camera is synchronized with the light source to shutter light when the light source is not producing light.

12. The imaging system as claimed in claim 1 wherein the light source is adapted to produce light that includes at least two different wavelengths.

13. The imaging system as claimed in claim 1 further comprising a filter disposed in front of the camera for filtering light from the camera that has a wavelength which falls beneath a defined threshold.

14. The imaging system as claimed in claim 13 wherein the filter is a long wavelength pass cutoff filter.

15. The imaging system as claimed in claim 14 wherein the filter is long wavelength pass cutoff filter that filters light from the camera with a wavelength that falls beneath 425 nm.

16. A method for capturing an image of an object in a low visibility environment using a camera, the object having an exterior, the method comprising the steps of:
(a) coating at least a portion of the exterior of the object with a light absorptive coating;
(b) illuminating the object with a light source adapted to produce light with a wavelength of no greater than 750 nm; and
(c) capturing the image of the object illuminated by the light source using the camera.

17. The method as claimed in claim 16 wherein the light absorptive coating is a fluorescent coating.

18. The method as claimed in claim 17 wherein the exterior coating on the object is a fluorescent coating with a maximum emission wavelength in the range between 415 nm and 725 nm.

19. The method as claimed in claim 16 wherein the light source is adapted to produce light with a wavelength in the range of 300-750 nm.

20. The method as claimed in claim 16 further comprising the step of disposing a filter in front of the camera for filtering light from the camera that has a wavelength which falls beneath a defined threshold.

21. The method as claimed in claim 20 wherein the filter is long wavelength pass cutoff filter that filters light from the camera with a wavelength that falls beneath 425 nm.
